(19) United States
(12) Patent Application Publication
(10) Pub. No.: US 2009/0066991 A1
(43) Pub. Date: Mar. 12, 2009

(54) SYSTEM AND METHOD FOR CLONING DOCUMENT PROCESSING DEVICES VIA SIMPLE NETWORK MANAGEMENT PROTOCOL

(76) Inventors: Sheng W. LEE, Irvine, CA (US); Ajit Sodhi, Irvine, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/851,152

(22) Filed: Sep. 6, 2007

(51) Int. Cl. G06F 3/12; H04N 1/04

(52) U.S. Cl. 358/1.15; 358/474

(57) ABSTRACT

The subject application is directed to a system and method for cloning of document processing devices via simple network management protocol. A management information base object is first retrieved corresponding to commonly configurable parameters of document processing devices. Object identifier data associated with the commonly configurable parameters is then displayed. Selection data is thereafter received corresponding to a selected subset of the object identifiers. A selected source of the configuration data is received corresponding to source data. The configuration data is then retrieved based upon the received source data. Target data is then received corresponding to selected document processing devices for which a configuration thereof is desired. Retrieved configuration data is then communicated to each of the selected document processing devices according to the received target data corresponding to the selected subset of object identifiers.

### BACKGROUND OF THE INVENTION

The subject application is directed generally to configuration of document processing devices, and is particularly applicable to configuration cloning of document processing devices via the Simple Network Management Protocol.

Document processing devices are in widespread use today include copiers, printers, scanners, facsimile machines, plotters, electronic mail gateways, and the like. More recently, two or more of such machine functions have been combined into a single device, referred to as a multifunction peripheral or MFP.

Many enterprises will distribute document processing devices throughout an office, within a building, among multiple buildings, or among multiple locations. As might be expected, there is a substantial time investment required to configure machines, particularly when many are placed in use and especially when they are dispersed in physically disparate locations. Most modern office operations employ wireless or wired networking between devices such as workstations, servers, and document processing devices. It is often advantageous, particularly when many devices are to be configured similarly, to clone a preselected configuration over similar devices. Such configuration information may include configurable system parameters, machine state information, or information such as address books, document templates, or other commonly used features or files.

While it is possible to clone device configurations using transportable media, such as a compact disk, such an operation requires an administrator to physically visit each device for configuration, or for updating of configuration information. While network configuration may be advantageous, additional software or other system properties must be added or configured to allow remote configuration.

### SUMMARY OF THE INVENTION

In accordance with one embodiment of the subject application, there is provided a system and method for configuration of document processing devices.

Further, in accordance with one embodiment of the subject application, there is provided a system and method for configuration cloning of document processing devices.

Still further, in accordance with one embodiment of the subject application, there is provided a system for configuration cloning of document processing devices via simple network management protocol. The system comprises means adapted for retrieving a management information base object data corresponding to commonly configurable parameters of each of a plurality of document processing devices and means adapted for displaying data corresponding to each of a plurality of object identifiers associated with the commonly configurable parameters. The system also comprises means adapted for receiving selection data corresponding to a selected subset of the plurality of object identifiers and means adapted for receiving source data corresponding to a selected source of configuration data. The system further includes data retrieval means adapted for retrieving configuration data in accordance with received source data and means adapted for receiving target data corresponding to selected document processing devices for which configuration is desired. The system also includes output means adapted for communicating retrieved configuration data corresponding to the selected subset of object identifiers to each of the selected document processing devices in accordance with received target data.

In one embodiment of the subject application, the system further comprises storage means adapted for storing clone data inclusive of received selection data and received configuration data, retrieval means adapted for selectively retrieving clone data corresponding to a requested installation of selection data stored in the storage means, and means adapted for communicating retrieved clone data to the output means.

In another embodiment of the subject application, the system also includes means adapted for displaying data representative of each of a plurality of stored clone data sets stored in the storage means, means adapted for receiving retrieval selection data in accordance with a display of stored clone data sets. In such embodiment, the retrieval means includes means adapted for selectively retrieving clone data in accordance with received retrieval selection data.

In yet another embodiment of the subject application, the data retrieval means includes means adapted for generating an SNMP GET command to a device specified by received source data.

In a further embodiment of the subject application, the output means includes means adapted for generating an SNMP SET command to each device specified by received target data.

Still further, in accordance with one embodiment of the subject application, there is provided a method for cloning of document processing devices via simple network management protocol in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for cloning of document processing devices via simple network management protocol according to one embodiment of the subject application;

FIG. 2 is a block diagram illustrating device hardware for use in the system for cloning of document processing devices via simple network management protocol according to one embodiment of the subject application;

FIG. 3 is a functional diagram illustrating the device for use in the system for cloning of document processing devices via simple network management protocol according to one embodiment of the subject application;

FIG. 4 is a block diagram illustrating controller hardware for use in the system for cloning of document processing devices via simple network management protocol according to one embodiment of the subject application;

FIG. 5 is a functional diagram illustrating the controller for use in the system for cloning of document processing devices via simple network management protocol according to one embodiment of the subject application;

FIG. 6 is a block diagram illustrating a workstation for use in the system for cloning of document processing devices via simple network management protocol according to one embodiment of the subject application;

FIG. 7 is a flowchart illustrating a method for cloning of document processing devices via simple network management protocol according to one embodiment of the subject application; and

FIG. 8 is a flowchart illustrating a method for cloning of document processing devices via simple network management protocol according to one embodiment of the subject application.

### DETAILED DESCRIPTION OF THE PREFERRED EMBODIMENT

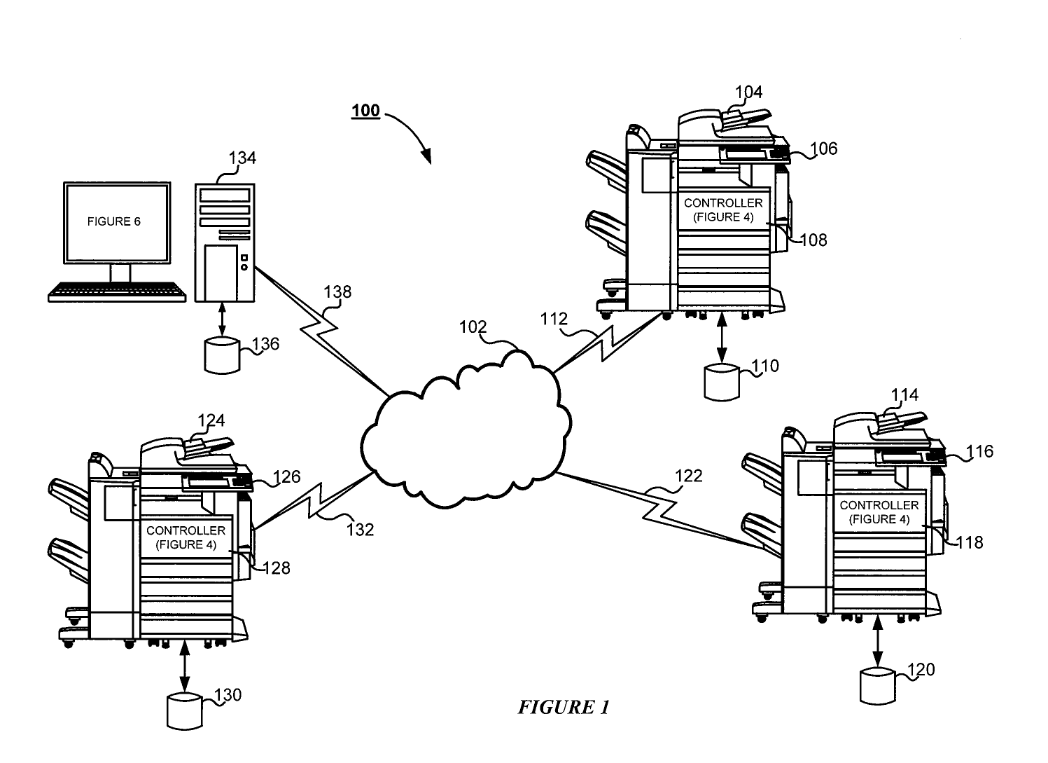

The subject application is directed to a system and method for configuration of document processing devices. In particular, the subject application is directed to a system and method for configuration cloning of document processing devices. It will become apparent to those skilled in the art that the system and method described herein are suitably adapted to a plurality of varying electronic fields employing network management, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for cloning of document processing devices via simple network management protocol in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

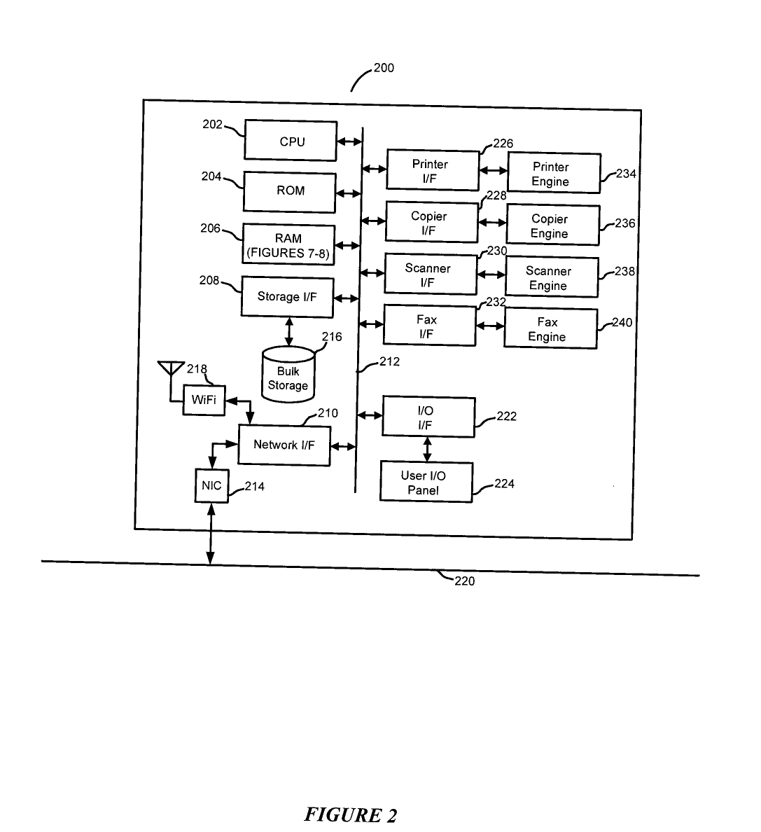

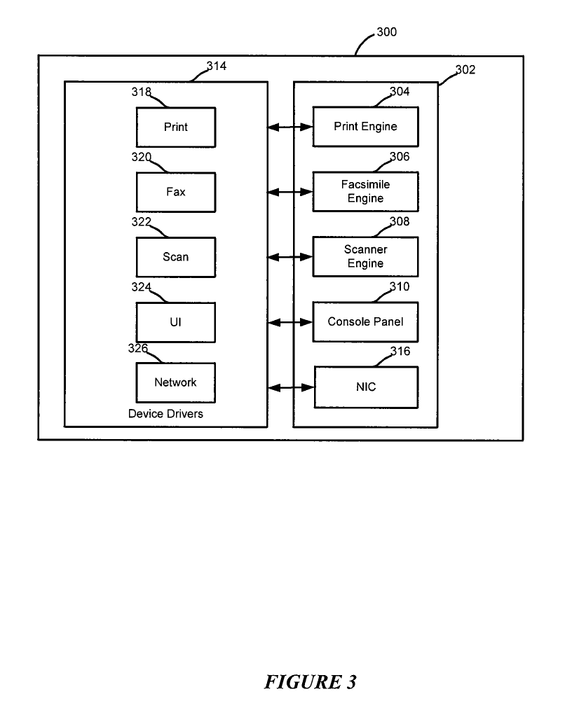

The system 100 also includes a first document processing device 104, a second document processing device 114, and a third document processing device 124, which are depicted in FIG. 1 as multifunction peripheral devices, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing devices 104, 114, and 124 are suitably adapted to provide document processing services to external or network devices. Preferably, the document processing devices 104, 114, and 124 include hardware, software, and any suitable combination thereof, configured to interact with an associated user, a networked device, or the like. The functioning of the document processing devices 104, 114, and 124 will better be understood in conjunction with the block diagrams illustrated in FIGS. 2 and 3, explained in greater detail below.

According to one embodiment of the subject application, the document processing devices 104, 114, and 124 are suitably equipped to receive a plurality of portable storage media, including, without limitation, Firewire drive, USB drive, SD, MMC, XD, Compact Flash, Memory Stick, and the like. In the preferred embodiment of the subject application, the document processing devices 104, 114, and 124 further include associated user interfaces 106, 116, and 126, respectively. The user interfaces 106, 116, and 126, such as a touch-screen, LCD display, touch-panel, alpha-numeric keypad, or the like, enable an associated user to interact directly with the corresponding document processing device 104, 114, and 124. In accordance with the preferred embodiment of the subject application, the user interfaces 106, 116, and 126 are advantageously used to communicate information to the associated user and receive selections from the associated user. The skilled artisan will appreciate that the user interfaces 106, 116, and 126 comprise various components, suitably adapted to present data to the associated user, as are known in the art. In accordance with one embodiment of the subject application, the user interfaces 106, 116, and 126 comprise a display, suitably adapted to display one or more graphical elements, text data, images, or the like, to an associated user, receive input from the associated user, and communicate the same to a backend component, such as a controller 108, 118, or 128, as explained in greater detail below. Preferably, the document processing devices 104, 114, and 124 are communicatively coupled to the computer network 102 via suitable communications links 112, 122, and 132. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

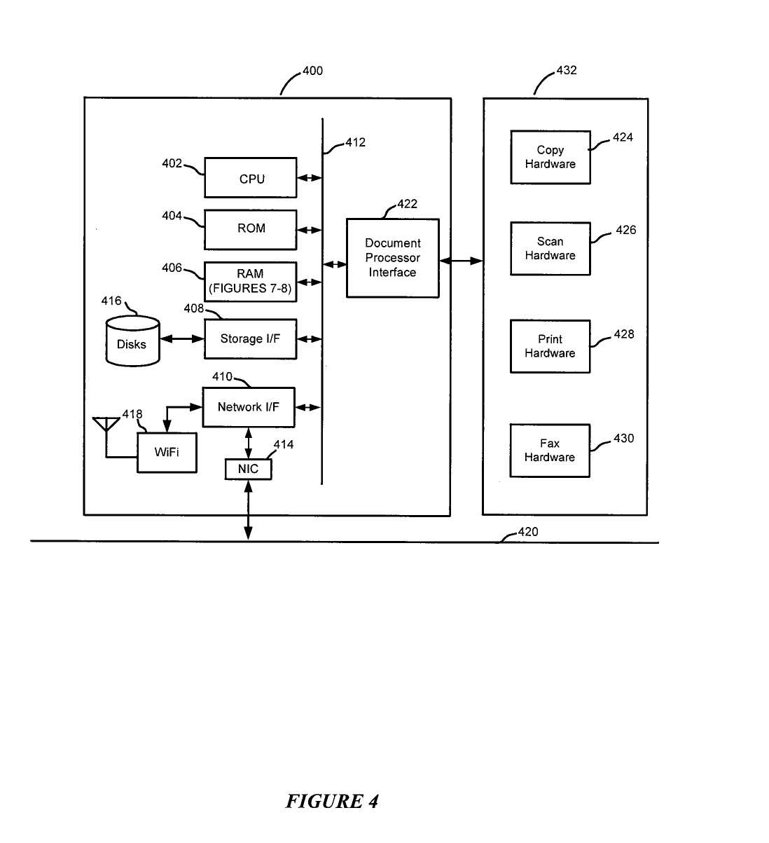

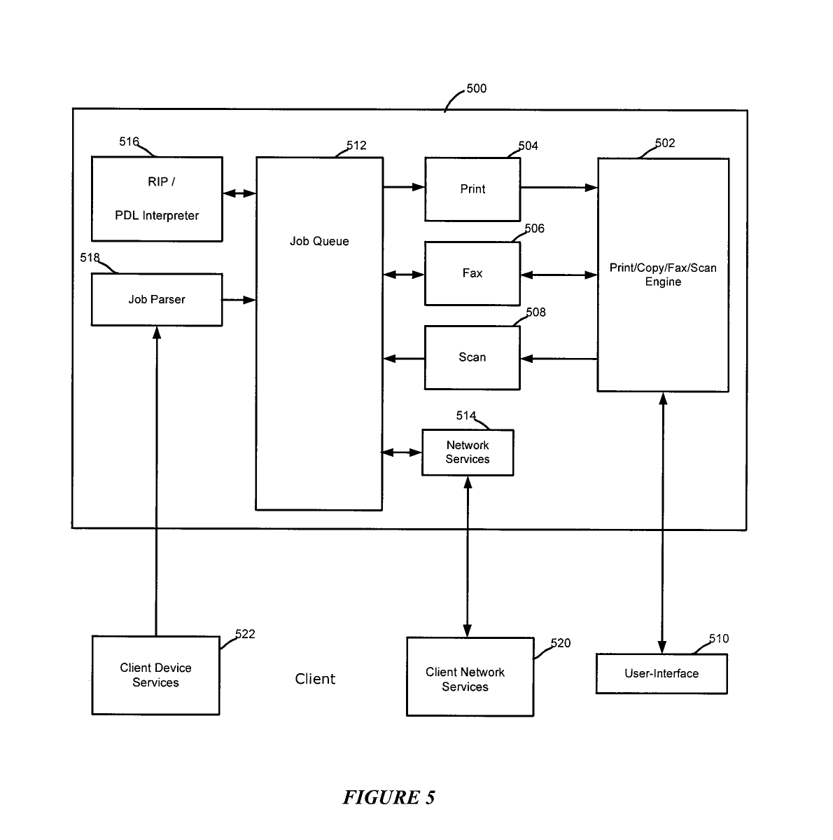

In accordance with one embodiment of the subject application, the document processing devices 104, 114, and 124 further incorporate an associated backend component, designated as the controllers 108, 118, and 128, suitably adapted to facilitate the operations of the corresponding document processing device 104, 114, and 124, as will be understood by those skilled in the art. Preferably, the controllers 108, 118, and 128 are embodied as hardware, software, or any suitable combination thereof, configured to control the operations of the associated document processing device 104, 114, and 124, facilitate the display of images via the associated user interface 106, 116, and 126, direct the manipulation of electronic image data, and the like. For purposes of explanation, the controllers 108, 118, and 128 are used to refer to any myriad of components associated with the document processing devices 104, 114, and 124, including hardware, software, or combinations thereof, functioning to perform, cause to be performed, control, or otherwise direct the methodologies described hereinafter. It will be understood by those skilled in the art that the methodologies described with respect to the controllers 108, 118, and 128 are capable of being performed by any general purpose computing system, known in the art, and thus the controllers 108, 118, and 128 are representative of such a general computing device and is intended as such when used hereinafter. Furthermore, the use of the controllers 108, 118, and 128 hereinafter is for the example embodiment only, and other embodiments, which will be apparent to one skilled in the art, are capable of employing the system and method for cloning of document processing devices via simple network management protocol of the subject application. The functioning of the controllers 108, 118, and 128 will better be understood in conjunction with the block diagrams illustrated in FIGS. 4 and 5, explained in greater detail below.

Communicatively coupled to the document processing devices 104, 114, and 124 are data storage devices 110, 120, and 130, respectively. In accordance with one embodiment of the subject application, the data storage devices 110, 120, and 130 are any mass storage device known in the art including, for example and without limitation, magnetic storage drives, a hard disk drive, optical storage devices, flash memory devices, or any suitable combination thereof. According to one embodiment of the subject application, the data storage devices 110, 120, and 130 are suitably adapted to store document data, image data, database data, or the like. It will be appreciated by those skilled in the art that while illustrated in FIG. 1 as being a separate component of the system 100, the data storage devices 110, 120, and 130 are capable of being implemented as internal storage component of the document processing devices 104, 114, and 124, a component of the controllers 108, 118, and 128, or the like, such as, for example and without limitation, an internal hard disk drive, or the like.

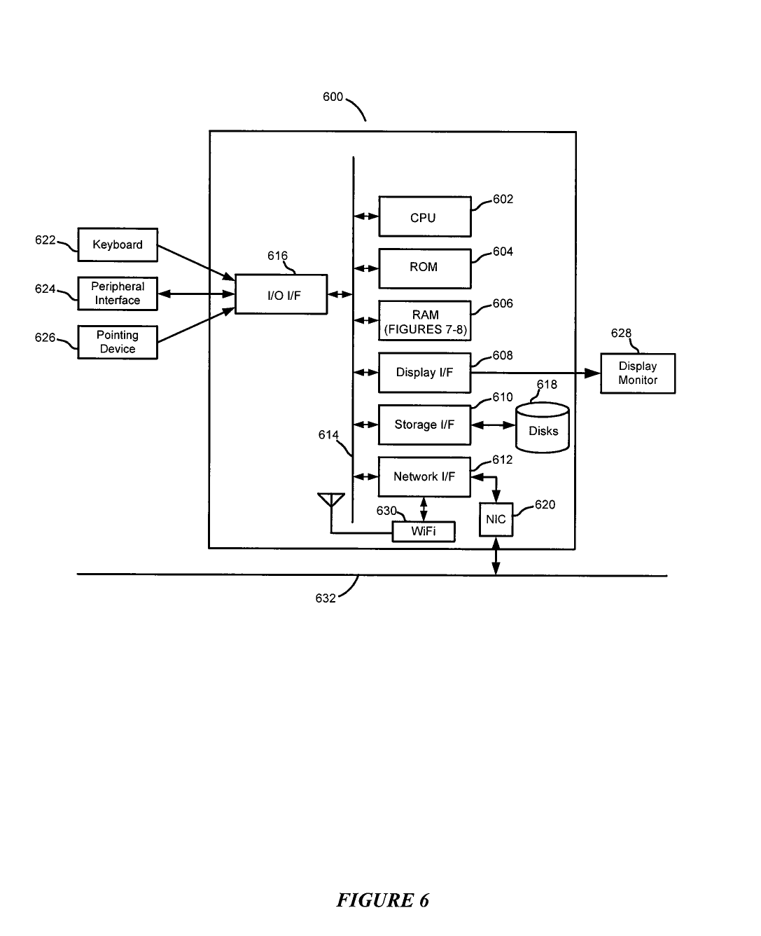

The system 100 illustrated in FIG. 1 further depicts a user device 134, in data communication with the computer network 102 via a communications link 138. It will be appreciated by those skilled in the art that the user device 134 is shown in FIG. 1 as a computer workstation for illustration purposes only. As will be understood by those skilled in the art, the user device 134 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 138 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 134 is suitably adapted to generate and transmit electronic documents, document processing instructions, user interface modifications, upgrades, updates, personalization data, or the like, to the document processing devices 104, 114, and 124, or any other similar device coupled to the computer network 102. In accordance with one embodiment of the subject application, the user device 134 includes a software utility operative thereon to facilitate Secure Network Management Protocol (SNMP) cloning of configuration data associated with document processing devices 104, 114, and 124. The functioning of the user device 134 will be better understood in conjunction with the block diagrams illustrated in FIG. 6, explained in greater detail below.

Communicatively coupled to the user device 134 is a data storage device 136. According to one embodiment of the subject application, the data storage device 136 is any mass storage device known in the art including, for example and without limitation, magnetic storage drives, a hard disk drive, optical storage devices, flash memory devices, or any suitable combination thereof. According to one embodiment, the data storage device 136 is suitably adapted to store configuration data, object IDs, management information base objects, files, modules, document data, image data, database data, or the like. It will be appreciated by those skilled in the art that while illustrated in FIG. 1 as being a component of the user device 134, e.g., an internal hard disk drive, the data storage device 136 is capable of being implemented as a network-based storage, such as a server, dedicated workstation, or the like. In accordance with one embodiment of the subject application, the data storage device 136 functions as permanent data storage, storing configuration data corresponding to document processing devices 104, 114, 124, and the like, coupled to the computer network 102.

Turning now to FIG. 2, illustrated is a representative architecture of a suitable device 200, shown in FIG. 1 as the document processing devices 104, 114, and 124, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device (shown in FIG. 1 as the document processing devices 104, 114, and 124) for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controllers 108, 118, and 128, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 514 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with bus the 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing devices 104, 114, and 124, which includes the controller 400 of FIG. 4, (shown in FIG. 1 as the controllers 108, 118, and 128) as an intelligent subsystem associated with a document processing device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The Parser 518 functions to interpret a received electronic document file and relay it to the job queue 512 for handling in connection with the afore-described functionality and components.

Turning now to FIG. 6, illustrated is a hardware diagram of a suitable workstation 600, shown in FIG. 1 as the user device 134, for use in connection with the subject system. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612. In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by on of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like

In operation, management information base object data is first retrieved corresponding to commonly configurable parameters of each of a plurality of document processing devices. Data corresponding to object identifiers associated with the commonly configurable parameters is then displayed. Selection data is thereafter received corresponding to a selected subset of the object identifiers. Source data is then received corresponding to a selected source of the configuration data. The configuration data is retrieved in accordance with the received source data. Target data is then received corresponding to selected document processing devices for which a configuration thereof is desired. Retrieved configuration data is then communicated to each of the selected document processing devices according to the received target data corresponding to the selected subset of object identifiers.

In accordance with one example embodiment of the subject application, a software utility, such as an SNMP utility, is first initiated on a user device 134. Preferably, the user device 134 is used by an administrator or other network supervisor to facilitate the configuration of a plurality of devices coupled to the computer network 102, e.g., the document processing devices 104, 114, and 124. Via interaction with the SNMP utility, e.g., a graphical user interface displayed to the administrative user via the user device 134, a determination is made whether cloned data is to be used to configure document processing devices 104, 114, and 124 coupled to the computer network 102. That is, a determination is made whether the administrator desires to use previously stored management information base object data and associated object identifiers corresponding to configurable document processing device parameters or to use new configuration parameters.

When the administrative user desires to create a new configuration, e.g., a new model for cloning using one of the document processing devices 104, 114, or 124, management information base object data of commonly configurable parameters are retrieved from the document processing devices 104, 114, and 124. Data corresponding to each object identifier associated with the commonly configurable parameters is then displayed to the administrative user via the SNMP utility operative on the user device 134. Through the SNMP utility, selection data is received from the administrative user corresponding to a selected subset of object identifiers. That is, the administrative user specifies which commonly configurable parameters, via their object identifiers, that the user desires to clone across multiple document processing devices 104, 114, 124. The administrative user then selects one of the available document processing devices 104, 114, or 124, as a source device from which values associated with the selected subset of identifiers are retrieved. An SNMP GET command is then generated by the SNMP utility of the user device 134 and communicated to the selected source device, e.g., document processing device 104.

The document processing device 104 then returns configuration data to the SNMP utility resident on the user device 134 corresponding to the selected subset of object identifiers. Stated another way, the source document processing device 104 returns setting values, configuration values, and the like, to the SNMP utility in accordance with the SNMP GET command. A determination is then made whether the configuration data received from the source device 104 is to be stored for later use. When the administrative user desires to save the retrieved configuration data, it is stored in the data storage 136 associated with the user device 134 for later use.

Once the clone data has been stored, or upon a determination that the administrative user does not desire the storage of the configuration data, target data is received from the administrative user via the SNMP utility. According to one embodiment of the subject application, the target data corresponds to one or more document processing devices 114, 124, or the like, for which configuration (using the configuration data from the source device 104) is desired. The skilled artisan will appreciate that the subject application enables the administrative user to select one or more document processing device 114 or 124 coupled to the computer network 102 to become a clone of the source device 104, with respect to the selected configuration data. An SNMP SET command is then generated by the SNMP utility corresponding to instructions to implement the configuration data by each recipient device. Thereafter, the configuration data is communicated to each selected target device, e.g., the document processing devices 114 or 124, for implementation thereon.

When an administrator desires to use previously stored configuration data, e.g., clone data, the SNMP utility then facilitates the display, on the user device 134, of clone data sets stored in the associated data storage device 136. The SNMP utility then receives a selection from the administrative user of one of the stored clone data sets and retrieves the selected clone data from the data storage device 136. The user then selects those document processing devices 104, 114, and/or 124, i.e., the target devices, which are to receive the clone data via the SNMP utility. An SNMP SET command is then generated inclusive of the clone data retrieved from the data storage device 136. The selected clone data is then communicated to the designated document processing devices 104, 114, and/or 124 from the user device 134 via the computer network 102. It will be understood by those skilled in the art that upon receipt of the SNMP SET command, a targeted document processing device 104, 114, or 124, processes the command and implements the changes to the configuration thereof.

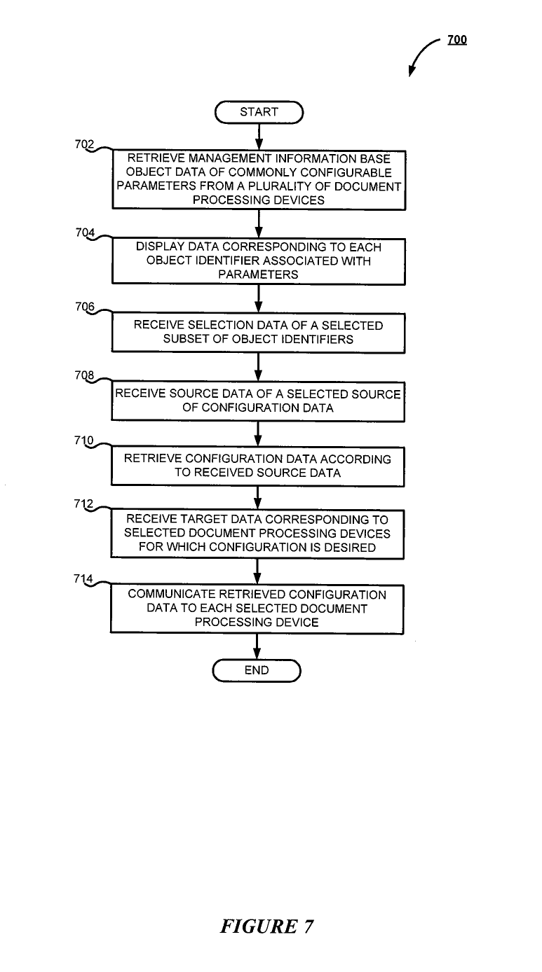

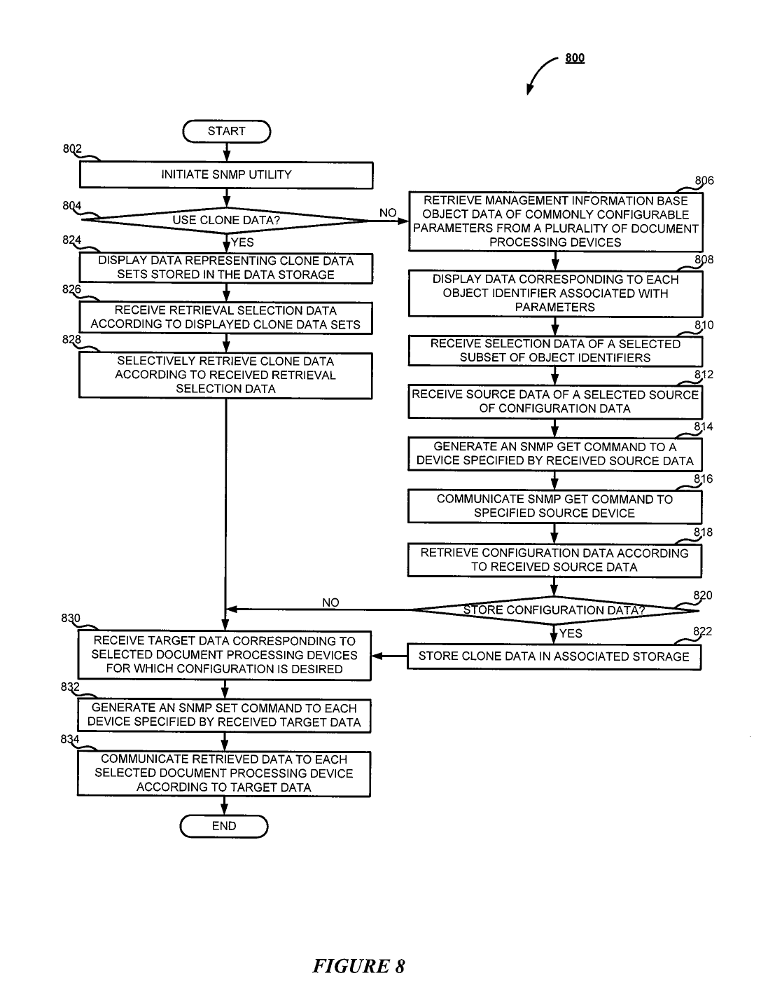

The skilled artisan will appreciate that the subject system 100 and components described above with respect to FIG. 1, FIG. 2, FIG. 3, FIG. 4, FIG. 5, and FIG. 6 will be better understood in conjunction with the methodologies described hereinafter with respect to FIG. 7 and FIG. 8. Turning now to FIG. 7, there is shown a flowchart 700 illustrating a method for cloning of document processing devices via simple network management protocol in accordance with one embodiment of the subject application. Beginning at step 702, management information base object data is first retrieved corresponding to commonly configurable parameters of each of a plurality of document processing devices. For example and without limitation, a suitable software utility, resident on an associated administrative user device 134, retrieves management information base objects corresponding to document processing device 104, 114, and 124 configuration settings.

At step 704, data corresponding to object identifiers associated with the commonly configurable parameters is then displayed. Selection data is then received at step 706, e.g., from an associated user, corresponding to a selected subset of the object identifiers. At step 708, source data is received corresponding to a selected source of the configuration data. For example, the administrative user selects the first document processing device 104 as the source of selected configuration data. The user device 134 then retrieves configuration data from the selected source device 104 at step 710. Target data is then received at step 712 corresponding to selected document processing devices, for example the second document processing device 114 and the third document processing device 124, for which configuration is desired. Thus, the skilled artisan will appreciate that the administrative user selects the document processing device 104 to clone and those document processing devices 114 and 124 to receive the clone data. The retrieved configuration data is then communicated to each targeted document processing device 114 and 124 at step 714. Thereafter, the targeted devices 114 and 124 implement the configuration data retrieved from the first document processing device 104, thereby rendering devices 114 and 124 configuration clones of the first document processing device 104.

Referring now to FIG. 8, there is shown a flowchart 800 illustrating a method for cloning of document processing devices via simple network management protocol in accordance with one embodiment of the subject application. The methodology of FIG. 8 begins at step 802, whereupon an SNMP software utility is initiated on a user device 134. In accordance with one embodiment of the subject application, the user device 134 is associated with an administrator or other network supervisor to facilitate the configuration of a plurality of document processing devices 104, 114, and 124 coupled to the computer network 102. A determination is then made at step 804 whether clone data is to be used in configuring one or more document processing devices 104, 114, and 124. That is, whether an administrative user desires to use previously generated and stored configuration data, or to generate new configuration data for cloning among the associated document processing devices 104, 114, and 124. In accordance with one embodiment of the subject application, administrative user interaction is facilitated via an SNMP utility resident on the user device 134, as will be appreciated by those skilled in the art.

When it is determined at step 804 that new configuration data is to be used, flow proceeds to step 806. At step 806, management information base object data corresponding to common configurable parameters is retrieved from the document processing devices 104, 114, and 124. Object identifiers associated with the commonly configurable parameters are then displayed to the administrative user via a graphical user interface associated with the SNMP utility at step 808. Selection data is then received at step 810 corresponding to a selected subset of the displayed object identifiers. Preferably, the administrative user selects, via the SNMP utility of the user device 134, those object identifiers associated with commonly configurable parameters to be cloned across the document processing devices 104, 114 and 124.

At step 812, source data of a selected source of the configuration data is received from the administrative user. That is, the administrative user, via the SNMP utility, selects one of the document processing devices 104, 114, or 124 as the source device for configuration data. The SNMP utility then generates, at step 814, an SNMP GET command corresponding to the selected subset of object identifiers. The SNMP GET command is then communicated, at step 816, to the source device, e.g., document processing device 104, specified by the received source data. Configuration data is then retrieved by the SNMP utility from the source device 104 at step 818 in accordance with the communicated SNMP GET command. According to one embodiment of the subject application, the retrieved configuration data corresponds to setting values, configuration values, etc., associated with the selected subset of object identifiers.

A determination is then made at step 820 whether the configuration data received from the source device 104 is to be stored for later use. When the administrative user desires to save the retrieved configuration data, flow proceeds to step 822, whereupon the configuration data is stored in the data storage 136 associated with the user device 134. Following storage of the configuration data at step 822, or upon a determination at step 820 that storage is not required, flow proceeds to step 830.

At step 830, target data corresponding to selected document processing devices, e.g., 114 and 124, for which configuration is desired is received from the administrative user via the SNMP utility. An SNMP SET command is then generated by the SNMP utility associated with the user device 134 at step 832 corresponding to the retrieved configuration data. The data is then communicated, at step 834 to each of the selected target devices 114 and 124, which thereafter implement the configuration data in accordance with the received SNMP SET command.

Returning to step 804, when it is determined that the administrative user desires to use previously stored configuration data, flow proceeds to step 824. At step 824, data representing clone data sets stored on the data storage device 136 is displayed to the administrative user via the SNMP utility associated with the user device 134. Retrieval selection data is then received from the administrative user corresponding to a selection of one of the displayed clone data sets at step 826. The selected clone data is then selectively retrieved by the SNMP utility at step 828 in accordance with the received user selection. Flow then progresses to step 830, whereupon target data corresponding to those devices for which configuration is desired is received. Thus when using previously stored clone data, the administrative user is able to select all document processing devices 104, 114, and 124 for configuration. An SNMP SET command is then generated to each target device 104, 114, and 124 inclusive of the selected clone data set at step 834. Thereafter, the retrieved clone data is communicated to each of the target devices 104, 114, and 124 at step 836 for implementation thereon.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for cloning of document processing devices via simple network management protocol comprising:
means adapted for retrieving a management information base object data corresponding to commonly configurable parameters of each of a plurality of document processing devices;
means adapted for displaying data corresponding to each of a plurality of object identifiers associated with the commonly configurable parameters;
means adapted for receiving selection data corresponding to a selected subset of the plurality of object identifiers;
means adapted for receiving source data corresponding to a selected source of configuration data;
data retrieval means adapted for retrieving configuration data in accordance with received source data;
means adapted for receiving target data corresponding to selected document processing devices for which configuration is desired; and
output means adapted for communicating retrieved configuration data corresponding to the selected subset of object identifiers to each of the selected document processing devices in accordance with received target data.

2. The system of claim 1 further comprising:
storage means adapted for storing clone data inclusive of received selection data and received configuration data;
retrieval means adapted for selectively retrieving clone data corresponding to a requested installation of selection data stored in the storage means; and
means adapted for communicating retrieved clone data to the output means.

3. The system of claim 2 further comprising:
means adapted for displaying data representative of each of a plurality of stored clone data sets stored in the storage means;
means adapted for receiving retrieval selection data in accordance with a display of stored clone data sets; and
wherein the retrieval means includes means adapted for selectively retrieving clone data in accordance with received retrieval selection data.

4. The system of claim 1 wherein the data retrieval means includes means adapted for generating an SNMP GET command to a device specified by received source data.

5. The system of claim 4 wherein the output means includes means adapted for generating an SNMP SET command to each device specified by received target data.

6. A method for cloning of document processing devices via simple network management protocol comprising the steps of:
retrieving a management information base object data corresponding to commonly configurable parameters of each of a plurality of document processing devices;
displaying data corresponding to each of a plurality of object identifiers associated with the commonly configurable parameters;
receiving selection data corresponding to a selected subset of the plurality of object identifiers;
receiving source data corresponding to a selected source of configuration data;
retrieving configuration data in accordance with received source data;
receiving target data corresponding to selected document processing devices for which configuration is desired; and
communicating retrieved configuration data corresponding to the selected subset of object identifiers to each of the selected document processing devices in accordance with received target data.

7. The method of claim 6 further comprising the steps of:
storing clone data inclusive of received selection data and received configuration data in an associated storage;
selectively retrieving clone data corresponding to a requested installation of selection data stored in the storage; and
communicating retrieved clone data to each of the selected document processing devices in accordance with received target data.

8. The method of claim 7 further comprising the steps of:
displaying data representative of each of a plurality of stored clone data sets stored in the storage;
receiving retrieval selection data in accordance with a display of stored clone data sets; and
selectively retrieving clone data in accordance with received retrieval selection data.

9. The method of claim 6 wherein the step of retrieving configuration data includes generating an SNMP GET command to a device specified by received source data.

10. The method of claim 9 wherein the step of communicating retrieved configuration data includes generating an SNMP SET command to each device specified by received target data.

11. A computer-implemented method for cloning of document processing devices via simple network management protocol comprising the steps of:
retrieving a management information base object data corresponding to commonly configurable parameters of each of a plurality of document processing devices;
displaying data corresponding to each of a plurality of object identifiers associated with the commonly configurable parameters;
receiving selection data corresponding to a selected subset of the plurality of object identifiers;
receiving source data corresponding to a selected source of configuration data;
retrieving configuration data in accordance with received source data;
receiving target data corresponding to selected document processing devices for which configuration is desired; and
communicating retrieved configuration data corresponding to the selected subset of object identifiers to each of the selected document processing devices in accordance with received target data.

12. The computer-implemented method of claim 11 further comprising the steps of:
storing clone data inclusive of received selection data and received configuration data in an associated storage;
selectively retrieving clone data corresponding to a requested installation of selection data stored in the storage; and
communicating retrieved clone data to each of the selected document processing devices in accordance with received target data.

13. The computer-implemented method of claim 11 further comprising the steps of:
displaying data representative of each of a plurality of stored clone data sets stored in the storage;
receiving retrieval selection data in accordance with a display of stored clone data sets; and
selectively retrieving clone data in accordance with received retrieval selection data.

14. The computer-implemented method of claim 11 wherein the step of retrieving configuration data includes generating an SNMP GET command to a device specified by received source data.

15. The computer-implemented method of claim 14 wherein the step of communicating retrieved configuration data includes generating an SNMP SET command to each device specified by received target data.
